(19) United States
(12) Patent Application Publication
(10) Pub. No.: US 2004/0119712 A1
(43) Pub. Date: Jun. 24, 2004

(54) System and method for representing multi-dimensional patient health

(76) Inventors: Bruce H. Kenknight, Maple Grove, MN (US); Scott Thomas Mazar, Inver Grove Heights, MN (US)

Correspondence Address: MERCHANT & GOULD PC, P.O. BOX 2903, MINNEAPOLIS, MN, 55402-0903, US

(21) Appl. No.: 10/324,659

(22) Filed: Dec. 19, 2002

(51) Int. Cl. G06T 11/20

(52) U.S. Cl. 345/440

(57) ABSTRACT

Methods and systems for graphically representing a multi-dimensional view of patient health are disclosed. A preferred embodiment uses a helical display of temporal attributes of patient health that allows a clinician to view not only a comprehensive representation of patient health, but also view fine-grain or customized representations of patent health data using commonly available techniques to manipulate the data points of the helical structure.

### TECHNICAL FIELD

The present system and method relates generally to a Data Management System for graphically visualizing patient data and particularly, but not by way of limitation, to such a system adapted for rapid visualization of temporally periodic attributes of patient health, rapid identification of singularities in a patient's health, and rapid identification of trends in a patient's health.

### BACKGROUND

It is said that a picture is worth a thousand words. However, more often than not, word and numbers are used to explain complex ideas and problems because they represent the most common denominator of understanding such ideas and problems. Even in esoteric scientific circles, where formulae often represent very complex ideas, traditional ways of conveying ideas are nevertheless employed to put complex ideas in a form suitable for mass consumption. Thus, advances in technology, while often increasing our ability to understand complex problems, challenges us to use new paradigms of explaining that understanding—paradigms that allow us to quickly perceive and understand complex technological output. This challenge holds true even in the context of diagnosing and treating disease.

As the diagnosis and treatment of disease struggles to keep pace with advances in medical technology, clinicians often face the daunting task of trying to assimilate vast amounts of patient and medical data into a coherent form the clinician can quickly access and utilize to efficiently diagnose patient health. More often than not, patient data and other medical information are presented to the clinician in the form of cumbersome patient charts and other paper documents or graphs. Traditionally, clinicians were tasked with the burden of wading through this sea of patient biometric data or had to rely on the expertise and input of colleagues to properly assess the clinical relevance of medical information. The use of computers has somewhat lessened this burden. However, even with computers, electronically presented clinical data is often no more sophisticated than an electronic reproduction of hard copy. So, while computers have greatly improved medical information access and storage, novel ways of presenting such information using computers or other electronic technologies are still being explored.

One novel way of presenting information is to present it in the form or representation of a three-dimensional structure. As the users of information presented in this fashion become more accustomed with how the data has been subsumed within the structure, they become better equipped to understand the complexities of the data and more attuned to quickly recognizing data deviations or trends. In addition, the more data subsumed within the structure, the more revealing the structure's shape or morphology in assisting the user in interpreting the data. In other words, the structure's form (its morphology) tends to illustrate more clearly data trends or deviations much in the way that a bell curve graph is more revealing than the table of variables that form the curve. However, the prior art does not focus on the morphology of graphically represented data as a way to interpret the data.

For example, U.S. Pat. No. 5,867,165 to Neill discloses a diary display and storage device using a three-dimensional helical structure onto which visual data can be appended. Alternatively, the three-dimensional structure can be created by a series of interlocking data units. This allows the visual representation of data according to the sequence in which the information occurs. However, Neill's mechanical device limits the amount of data a user can efficiently comprehend because of the obvious physical constraints of the device—the more data included on the Neill helix, the more physically cumbersome the device.

This problem is partially solved in U.S. Pat. No. 5,917,500 to Johnson et al. Johnson uses a computer-generated model that facilitates and enhances the comprehension of relationships, structures, patterns or trends within a data set or sets of data. However, the Johnson presentation is essentially linear and may require more intense scrutiny by the user before the user can recognize and interpret meaningful data correlations.

U.S. Pat. No. 6,212,509 to Poa et al. attempts to capture and display multidimensional data using computer-generated structures. Poa discloses the visualization of large bodies of complex multidimensional data in a so-called “topologically correct” low-dimension approximation.

However, none of the above references capture the idea of giving the morphology of the structure interpretive meaning in a way that assists the user, in this case a medical clinician, in viewing and understanding the clinical significance of the data. In other words, the graphical forms of the present invention provide not only an efficient way to present multi-dimensional data, but the multiple dimensions of the form itself, as created by the underlying data or configured by the user, confers interpretive meaning to the data.

Thus, for these and other reasons, there is a need for a system adapted for rapid visualization of large amounts of patient data in a graphical form that clearly shows the multi-dimensional aspect of the data and allows the clinician to clinically interpret the data based on the morphology of the graphical form. In this way, the system provides for a rapid and accurate analysis of temporal, qualitative and quantitative attributes of patient health and patient health trends. The system also reduces the analytical burden placed on clinicians by reducing vast amounts of clinical data to a more easily understood visual form.

### SUMMARY

According to one aspect of the invention, there is provided a system and method for representing multi-dimensional patient health using a system that graphically presents patient health data in a way that the structure of the graphical form illustrates the clinical significance of the medical data. The system comprises a Data Management System (“DMS”) adapted to contain large amounts of patient information and data, a graphical data presentation device accessible by a clinician or patient, and a presentation engine adapted to collapse the large amount of DMS data into a temporally coherent visual presentation that can be manipulated by commonly available three-dimensional visualization tools. As used herein, “patient data,” “patient health data,” “medical information” and “biometric data” are substantively synonymous terms as are the words “data” and “information.” Also, as used herein, a “clinician” can be a physician, physician assistant (PA), nurse, medical technologist, or any other patient health care provider.

In one embodiment, the Data Management System comprises a data management module, an analysis module, a presentation engine, and user means to resolve and manipulate the presented data. The System is configured to accommodate large amounts of patient health or biometric data and present that data as a graphical display.

In another embodiment, the data management module is adapted to receive, store and archive large amounts of patient health data. Patient health data may comprise any physiological parameter suitable for quantitative or qualitative measurement. By way of non-limiting example only, such physiological parameters might include a patient's body temperature, heart rate, heart rate variability, body weight, cardiovascular efficiency or level of physical activity.

In a further embodiment, the analysis module is adapted to analyze patient health data for efficient presentation to the presentation engine. The analysis component includes the use of clinically derived algorithms to analyze biometric data in a way that yields clinically relevant information. By using clinically derived algorithms to analyze biometric data, there is consistent delivery of quality of care. Such consistency serves to improve the cost-effectiveness and efficiency of medical care by offloading at least part of the diagnostic burden placed on the clinician to the Data Management System. Analysis may also include the correlation of patient health data using known data correlation techniques or statistical analysis of patient health data. In addition, the analysis of biometric data may comprise identifying singularities in patient health and/or trends in patient health.

In yet another embodiment, the presentation engine is adapted to collapse the large amounts of analyzed patient health data into a temporally coherent visual presentation in which the morphology of the displayed presentation provides a multi-dimensional representation of patient health. The visual presentation comprises a higher order geometric figure presented on a conventional two-dimensional display where the two-dimensional display has significantly higher resolution than the displayed geometric figure. The higher order geometric figure may comprise a representation of biometric data in the form of a series of stacked doughnut shapes.

In a preferred embodiment of the system and method for graphically representing multi-dimensional patient health, the visual presentation graphic comprises a high-resolution helical structure further comprising fast and slow temporal axes. The helical structure is adaptable for manipulation by commonly available three-dimensional visualization tools. In this way, a clinician may configure a presentation of specific biometric data, or a combination of biometric data sets, best suited for the clinical situation.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a schematic/block diagram illustrating generally, among other things, one embodiment of the system and method for representing multi-dimensional patient health.

FIG. 2 is a schematic/block diagram illustrating generally, among other things, another embodiment of the system and method for representing multi-dimensional patient health that illustrates the system interacting with an implantable medical device and a clinician or patient.

FIG. 3 is a state diagram illustrating generally, among other things, another embodiment of the functional components of the system and method for representing multi-dimensional patient health that illustrates the functional components of the system interacting with an external computer system and a clinician or patient.

FIG. 4 is a schematic/block diagram illustrating generally, among other things, various forms or dimensions of presenting patient health data in another embodiment of the system and method for representing multi-dimensional patient health.

FIG. 5 is a schematic/block diagram illustrating generally, among other things, other various forms or dimensions of presenting patient health data in another embodiment of the system and method for representing multi-dimensional patient health.

FIG. 6 is a schematic/block diagram illustrating generally, among other things, a helical form or dimension of presenting patient health data in another embodiment of the system and method for representing multi-dimensional patient health.

### DETAILED DESCRIPTION

In the following detailed description, reference is made to the accompanying drawings that form a part hereof, and in which are shown by way of illustration, specific embodiments or examples. These embodiments may be combined, other embodiments may be utilized, and structural, logical, and electrical changes may be made without departing from the spirit and scope of the present invention. The following detailed description is, therefore, not to be taken in a limiting sense, and the scope of the present invention is defined by the appended claims and their equivalents.

The present system and method are described with respect to a Data Management System capable of representing a graphical view of multi-dimensional patient health. The system and method can provide clinicians with a means for rapid visualization of temporally periodic attributes of patient health, rapid identification of singularities in a patient's health and rapid identification of patient health trends. In providing such an overview of patient health in graphical format, the system is adapted to condense vast amounts of patient health or biometric data to a form that allows the clinician to rapidly identify correlations and trends. This helps reduce the burden on the clinician to analyze and synthesize reams of patient data most often kept in the form of voluminous and awkward paper documents.

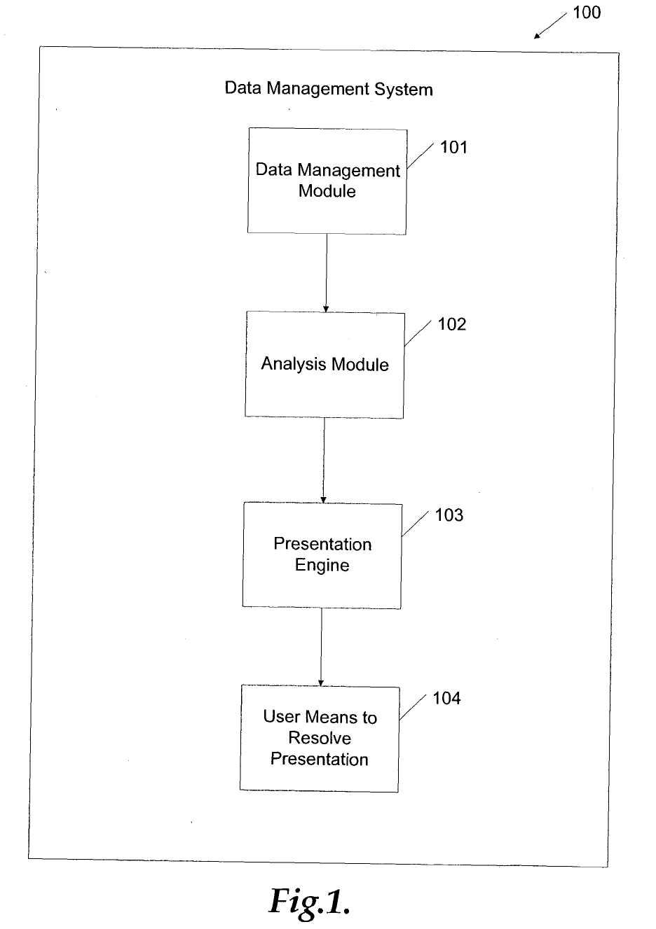

FIG. 1 is a schematic/block diagram illustrating generally an embodiment of the Data Management System 100 capable of graphically representing multi-dimensional patient health. The system further comprises data management module 101, analysis module 102, presentation engine 103, and user means 104 to resolve and manipulate the graphical representation.

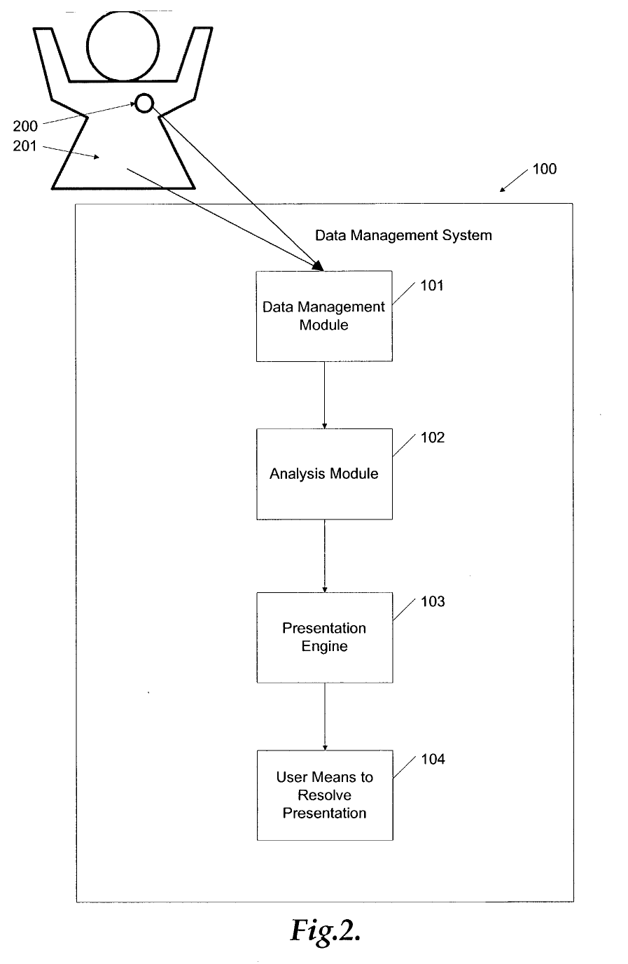

FIG. 2 is a schematic/block diagram illustrating generally an embodiment of the data management module 101 of the Data Management System 100. In this embodiment, the data management module 101 is adapted to receive, store and archive vast amounts of biometric data in a temporal fashion. Data for the data management module may be obtained automatically through the sensing function of an implantable medical device 200 or manually through input by a clinician 201 or patient 201, or both. In either automatic or manual mode, the data management module 101 is adapted to electronically receive, store and archive biometric data. By way of non-limiting example only, such data may comprise a temporal record of a patient's body temperature, heart rate, heart rate variability, body weight, cardiovascular efficiency or level of physical activity.

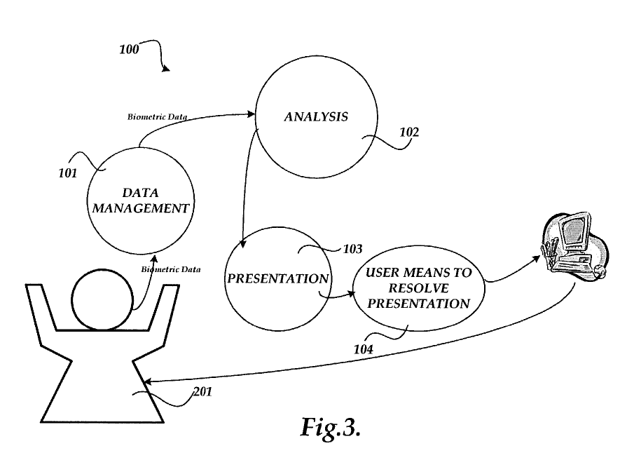

FIG. 3 is a state diagram illustrating generally the function of analysis module 102. Analysis module 102 is adapted to electronically receive temporal biometric data from data management module 101. Analysis module 102 is further adapted to analyze the biometric data. Analysis may comprise the use of clinically derived algorithms to analyze the biometric data in a way that yields a clinically relevant output. The algorithms can be the result of the extraction, codification and use of collected expert knowledge for the analysis or diagnosis of medical conditions. For example, the algorithms can comprise institutional diagnostic techniques used in specific clinical settings. By reducing the diagnostic methodologies of institutions like the Cleveland Clinic, the Mayo Clinic or the Kaiser Permanente system to algorithmic expression, a patient will enjoy the benefit of the diagnostic expertise of a leading medical institution without having to visit the institution. Analysis module 102 is further adapted to electronically communicate with presentation engine 103. As further illustrated in FIG. 3, presentation engine 103 is adapted to collapse the large amounts of analyzed patient health data into a temporally coherent visual presentation that can be manipulated by commonly available three-dimensional visualization tools. User means 104 may comprise a personal computer or other visual display device adapted to display the multi-dimensional representation of patient health to the patient or clinician.

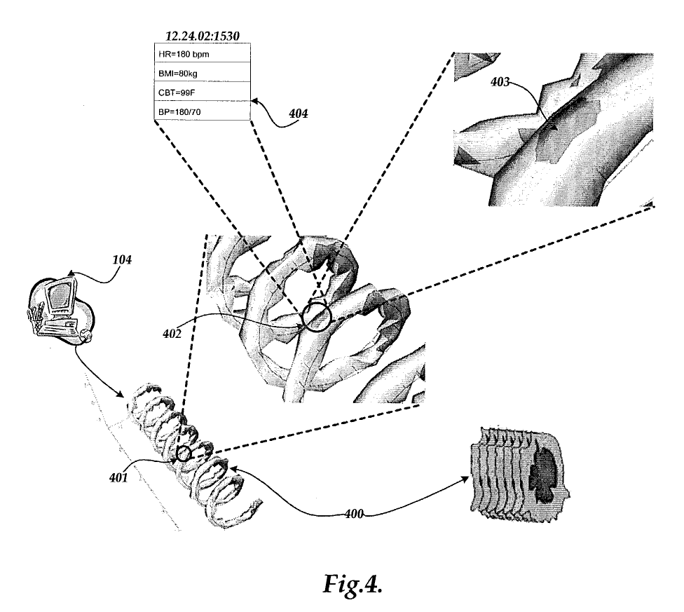

As illustrated in FIG. 4, such common visual manipulation tools may include CAD/CAM software or other computer software tools that allow the user to manipulate the view and further analyze the visual presentation 400. By way of non-limiting example only, a manipulated view may include rotating the visual presentation 400 in relation to a selected temporal axis to view a temporal series of biometric data points. By temporally arranging the presentation 400, the presentation of biometric information is visually coherent allowing the clinician or other user to visually observe the evolution of biometric variables. By further non-limiting example, a user, in this case a clinician, may further analyze the visual presentation 400 by focusing or zooming in on a segment 401 of the presentation 400. By selecting a segment 401 of the presentation 400, the clinician can view finer-grain biometric data of clinical interest. Further analysis might also include selecting a segment or data point 402 of a previously selected segment to view even finer-grain biometric data of interest. In this embodiment, the presentation engine is robust enough so that fine-grain selections of increasingly finer magnitudes 403 can themselves be graphically represented. In addition, by selecting a segment 401 or 402, a clinician may elect to view temporal biometric data in tabular form 404 instead of a graphical presentation 400.

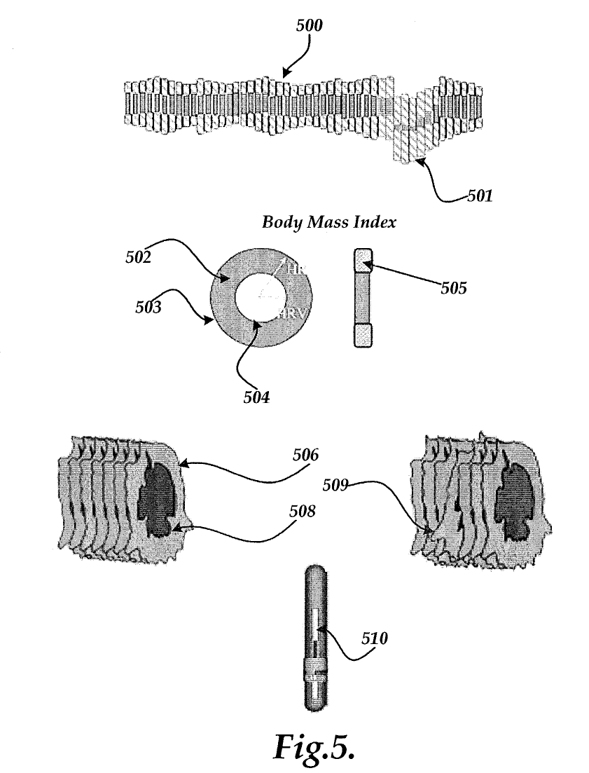

FIG. 5 is a schematic/block diagram illustrating generally an embodiment of the graphical representation of multi-dimensional patient health. In this embodiment, the presentation is in the form of a series of stacked doughnut shapes 500. The doughnuts can be offset 501 from center to represent additional dimensions of biometric data. By way of non-limiting example only, such additional dimensions may comprise representations of cardiac output, chamber pressure, blood chemistry, ejection fraction or thyroid or gastric markers. Each doughnut 502 may comprise a temporal snapshot of biometric data. By way of non-limiting example only, the outside radius 503 of the doughnut represented by radius HR may comprise a 24-hour representation of a patient's heart rate. As a patient's heart rate changes throughout the day, radius HR would lengthen or shorten as shown by varying radius HR 506. By way of further non-limiting example only, the inside radius of the doughnut represented by radius HRV 504 may comprise a 24-hour representation of a patient's heart rate variability or blood pressure. Using the blood pressure example, the length of radius HRV would lengthen or shorten depending on variations 508 in the patient's blood pressure. The width or thickness 505 of each doughnut may comprise a measurement of the patient's body mass index or weight during a 24-hour period. By way of non-limiting example only, the width 505 of the doughnut would increase as the patient's body mass increases and decrease as body mass decreases. Thus, a clinician could quickly and easily recognize a weight trend by viewing a succession of doughnut shapes 500. A clinician could also quickly and easily recognize other trends or changes 509 by observing changes in the form of the temporal, graphical representation. Other clinical events 510 may be displayed on the doughnut surface in temporal context. By way of non-limiting example only, such events might comprise cardiac arrhythmias, a fall suffered by the patient, dyspnea, anxiety or depression, a patient's sleeping habits and core body temperature in excess of a clinically determined range. Those skilled in the art will appreciate that a host of biometric data or clinical events may be shown by the graphical representation of FIG. 5.

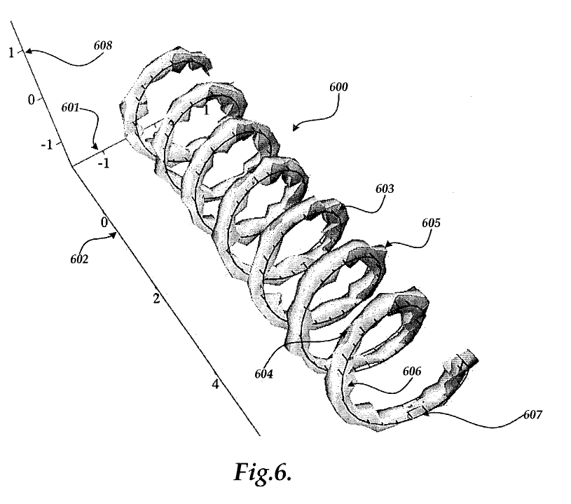

FIG. 6 is a schematic/block diagram illustrating generally an embodiment of the graphical representation of multi-dimensional patient health. In this embodiment, the presentation is in the form of a helical structure 600 comprising a finite coil. Finite space is utilized to capture bounded analog values within a reasonable range of variation. As further illustrated in FIG. 6, the helix comprises logical fast and slow axes that are temporally coherent. The fast axis is shown by the helical curve of the helix moving generally in the direction of line 601. The slow axis is parallel to line 602 and traverses the length of the helix 600 from end to end. By way of non-limiting example only, movement along the fast axis 601 may illustrate temporal relations in terms of hours. In contrast, movement along the slow axis 602 may illustrate temporal relations in terms of days. In this embodiment, each complete turn of the helix represents 24 hours. Within a 24-hour period, day and night can be represented by subtle coloration 603 changes on the surface of the fast axis 601 of the helix. The helical structure 600 comprises adjustable dimensions in the pitch 608 of the helix and offset of the helix from a central axis. In this embodiment, the central axis may comprise a line parallel to axis 602 traversing the center of the helix 600 (of constant or varying pitch) from end to end. In addition, and by way of further non-limiting example only, more pronounced coloration 604 changes can be imposed on the fast axis 601 of the helix 600 to indicate, for instance, a cardiac arrhythmia. Other clinical events may be represented by other shape or size images imposed on the fast axis 601 of the helix 600. Subtle texture 605 changes can also be imposed on the fast axis 601 of the helix 600 to signify other clinical events, such as a sudden rise in body weight. As further illustrated on FIG. 6, other surface microstructure 606 can be imposed on the fast axis 601 of the helix to convey other clinical information upon zoomed-in viewing. The color 604 and texture 605 changes, and other surface microstructure 606 may indicate binary or roughly graduated clinical events. By way of non-limiting example only, a binary clinical event is of the type that can be represented as either existing or not, much in the way that binary computer language consists of zeros and ones. In contrast, and by way of non-limiting example only, a roughly graduated clinical event is of the type best represented as a continuum. In this embodiment, a binary clinical event may be imposed on the surface of the helix 600 in the form of a red dot or patch 604 representing, for example, the occurrence of an arrhythmia. A roughly graduated clinical event in this embodiment may be temporally imposed on the surface of the helix 600 in the form of a continuous change in color from, for example, yellow to orange to red to represent a deteriorating physical condition of an urgent nature. Fiducials 607 can also be imposed along the fast axis 601 of the helix to guide coarse interpretation of presented dimensional data or quickly recognize variances. Other dimensions of biometric data can be represented along pitch axis 608. In this embodiment, the radius in relation to a central axis traversing the length of the helix 600 would increase or decrease in relationship to the other dimension of biometric data. By assigning biometric data to a dimension relative to a radius from the central axis, a clinician or other user may analyze an instantaneous cross-section of the helical coil 600. Such an instantaneous cross-section may comprise a data point on the coil 600. Such analysis of an instantaneous cross-section of the helix 600 may assist the clinician or other user in drawing statistical conclusions from the biometric data or defining statistical parameters of biometric data for further analysis.

It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including,” “includes” and “in which” are used as the plain-English equivalents of the respective terms “comprising,” “comprises” and “wherein.”

What is claimed is:

1. A system for visualizing multi-dimensional patient health data comprising:
a. a data management module adapted to receive and store large amounts of patient health data;
b. an analysis module adapted to analyze the patient health data;
c. a presentation engine adapted to collapse the large amounts of patient health data into a temporally coherent visual presentation in which the morphology of the displayed presentation provides a user configurable multi-dimensional representation of patient health adapted for coherent axes to be visually optimized through increased resolution and manipulation of the multi-dimensional representation; and
d. user means to resolve and manipulate the multi-dimensional representation of analyzed patient health data.

2. The temporally coherent visual presentation of claim 1, wherein the temporal presentation comprises minutes.

3. The temporally coherent visual presentation of claim 1, wherein the temporal presentation comprises hours.

4. The temporally coherent visual presentation of claim 1, wherein the temporal presentation comprises days.

5. The temporally coherent visual presentation of claim 1, wherein the temporal presentation comprises weeks.

6. The temporally coherent visual presentation of claim 1, wherein the temporal presentation comprises months.

7. The temporally coherent visual presentation of claim 1, wherein the temporal presentation comprises years.

8. The system of claim 1, wherein the displayed multi-dimensional representation of analyzed patient health data is displayed in the form of a geometric figure.

9. The geometric figure of claim 8, wherein the figure comprises fast and slow axes.

10. The geometric figure of claim 9, wherein the figure comprises a series of stacked doughnut-like shapes.

11. The geometric figure of claim 9, wherein the figure comprises a helical structure.

12. The displayed helical structure of claim 11, wherein the helical structure comprises a finite coil cross-section with adjustable dimensions.

13. The adjustable dimensions of claim 12, wherein the adjustable dimensions comprise instantaneous diameter in pitch of the helical structure.

14. The adjustable dimensions of claim 12, wherein the adjustable dimensions comprise the helical structure offset from a central axis.

15. The adjustable dimensions of claim 12, wherein the adjustable dimensions comprise extending the instantaneous cross-section of the helical structure toward the central axis.

16. The adjustable dimensions of claim 12, wherein the adjustable dimensions comprise extending the instantaneous cross-section of the helical structure away from the central axis.

17. The adjustable dimensions of claim 12, wherein the adjustable dimensions comprise extending the width of the helical structure parallel to the central axis.

18. The displayed helical structure of claim 11, wherein the helical structure includes coloring to indicate binary clinical events.

19. The displayed helical structure of claim 11, wherein the helical structure includes texturing to indicate binary clinical events.

20. The displayed helical structure of claim 11, wherein the helical structure includes coloring to indicate roughly graduated clinical events.

21. The displayed helical structure of claim 11, wherein the helical structure includes texturing to indicate roughly graduated clinical events.

22. The displayed helical structure of claim 11, wherein the helical structure includes surface microstructure adapted to convey clinical information upon zoomed-in viewing.

23. The displayed helical structure of claim 11, wherein the helical structure includes fiducials to guide course interpretation of presented multi-dimensional patient data.

24. The system of claim 1, wherein the means to resolve and manipulate the multi-dimensional representation of analyzed patient health data comprises computer aided design tools.

25. The system of claim 1, wherein the means to resolve and manipulate the multi-dimensional representation comprises electronic tools that allow the user to zoom in on the representation to view and analyze fine-grain patient health data.

26. The electronic tools of claim 25, wherein the tools comprise a computer.

27. The means to resolve and manipulate the multi-dimensional representation of claim 25, wherein zooming in on the representation creates another visual representation of the fine-grain patient health data of a higher order.

28. The visualized higher order of claim 27, wherein the higher order is a two or higher dimensional representation of patient health data.

29. The visualized higher order of claim 27, wherein the higher order is another helical representation of patient health data.

30. The visualized higher order of claim 27, wherein the higher order is a tabular representation of patient health data.

31. The visualized higher order of claim 27, wherein the higher order is a multiple helical representation of patient health data.

32. The multiple helical representation of claim 31, wherein the multiple helical representation is a helical structure within a helical structure.

33. The user means to resolve and manipulate the multi-dimensional representation of analyzed patient health data of claim 1, wherein the means comprises computer software adapted to resolve and manipulate the multi-dimensional representation of patient health.

34. The user means to resolve and manipulate the multi-dimensional representation of analyzed patient health data of claim 1, wherein the means comprises computer aided design software adapted to resolve and manipulate the multi-dimensional representation of patient health.

35. The user means to resolve and manipulate the multi-dimensional representation of analyzed patient health data of claim 1, wherein the means comprises computer aided manufacturing software adapted to resolve and manipulate the multi-dimensional representation of patient health.

36. A method for visualizing multi-dimensional patient health data comprising the steps of:
a. receiving a large amount of patient health data;
b. storing a large amount of patient health data;
c. analyzing the patient health data;
d. presenting the patient health data in a graphical form of a temporally coherent visual presentation in which the morphology of the displayed presentation provides a user configurable multi-dimensional representation of patient health adapted for coherent axes to be visually optimized through increased resolution and manipulation of the multi-dimensional representation;
e. resolving the multi-dimensional representation of analyzed patient health data; and
f manipulating the multi-dimensional representation of analyzed patient health data.

37. The step of receiving a large amount of patient data of claim 36, wherein the step further comprises the step of populating a data management module with the data.

38. The step of storing a large amount of patient data of claim 36, wherein the step further comprises the step of populating a data management module with the data.

39. The step of analyzing patient data of claim 36, wherein the step further comprises the step of transmitting patient data to an analysis module for analysis.

40. The step of presenting patient data of claim 36, wherein the step further comprises the step of presenting the data in the graphical form of a series of stacked doughnuts.

41. The step of presenting patient data of claim 36, wherein the step further comprises the step of presenting the data in the graphical form of a helical structure.

42. The step of resolving the multi-dimensional representation of analyzed patient health data of claim 36, wherein the step further comprises the step of displaying the representation on a personal computer.

43. The step of manipulating the multi-dimensional representation of analyzed patient health data of claim 36, wherein the step further comprises the step of manipulating the data by using computer aided design software.

44. The step of manipulating the multi-dimensional representation of analyzed patient health data of claim 36, wherein the step further comprises the step of manipulating the data by using computer aided manufacturing software.

45. A method for visualizing multi-dimensional patient health data comprising the steps of:
a. receiving a large amount of patient health data by populating a data management module with patient health data;
b. storing a large amount of patient health data by populating a data management module with patient health data;
c. analyzing the patient health data by transmitting patient data from the data management module to an analysis module for analysis;
d. presenting the patient health data in a stacked doughnut graphical form of a temporally coherent visual presentation in which the morphology of the displayed presentation provides a user configurable multi-dimensional representation of patient health adapted for coherent axes to be visually optimized through increased resolution and manipulation of the multi-dimensional representation;
e. resolving the multi-dimensional representation of analyzed patient health data by displaying the representation on a personal computer; and
f. manipulating the multi-dimensional representation of analyzed patient health data by using computer aided design or manufacturing software.

46. A method for visualizing multi-dimensional patient health data comprising the steps of:
a. receiving a large amount of patient health data by populating a data management module with patient health data;
b. storing a large amount of patient health data by populating a data management module with patient health data;
c. analyzing the patient health data by transmitting patient data from the data management module to an analysis module for analysis;
d. presenting the patient health data in a helical graphical form of a temporally coherent visual presentation in which the morphology of the displayed presentation provides a user configurable multi-dimensional representation of patient health adapted for coherent axes to be visually optimized through increased resolution and manipulation of the multi-dimensional representation;
e. resolving the multi-dimensional representation of analyzed patient health data by displaying the representation on a personal computer; and
f. manipulating the multi-dimensional representation of analyzed patient health data by using computer aided design or manufacturing software.
